(19) United States
(12) Patent Application Publication
(10) Pub. No.: US 2023/0266288 A1
(43) Pub. Date: Aug. 24, 2023

(54) CHROMATOGRAPHIC ANALYZER AND PROGRAM FOR CHROMATOGRAPHIC ANALYSIS

(71) Applicant: SHIMADZU CORPORATION, Kyoto-shi (JP)

(72) Inventors: Yuji KATSUYAMA, Kyoto-shi (JP); Kiriko MATSUO, Kyoto-shi (JP); Rikito MARUMOTO, Kyoto-shi (JP)

(73) Assignee: SHIMADZU CORPORATION, Kyoto-shi (JP)

(21) Appl. No.: 18/088,205

(22) Filed: Dec. 23, 2022

(30) Foreign Application Priority Data
Feb. 24, 2022 (JP) 2022-026604

(51) Int. Cl. G01N 30/86

(52) U.S. Cl. CPC G01N 30/8631

(57) ABSTRACT

In a chromatographic analyzer which performs a measurement on multiple compounds for each of the multiple samples, a data-analysis processor calculates, for each sample, multiple pieces of numerical information obtained by data analysis on multiple compounds, based on measurement data. A table creator creates a two-dimensional table by arranging sample identifier in one direction of the table and compound identifier in the other direction, and assigning numerical information obtained for a combination of one sample and one compound to a cell of the table corresponding to the combination. A cell selection receiver displays the table on a display screen and receives a selection of a cell or cells according to a user operation on the displayed table. A selected information outputter outputs or displays the numerical information in the selected cell(s) in a predetermined format along with the sample and compound identifiers corresponding to the cell(s).

### TECHNICAL FIELD

The present invention relates to a chromatographic analyzer and a computer program to be used for a chromatographic analyzer. The “chromatographic analyzer” in the present description includes a liquid chromatographic analyzer (LC), gas chromatographic analyzer (GC), liquid chromatograph mass spectrometer (LC-MS), gas chromatograph mass spectrometer (GC-MS) and supercritical fluid chromatographic analyzer (SFC).

### BACKGROUND ART

In recent years, a quantitative analysis of multiple components in multiple analytes employing an LC-MS or GC-MS (this type of analysis is hereinafter called a “multi-analyte multi-component quantification analysis”) has been used in various areas, such as the testing of residual agricultural chemicals in foods, the testing of contaminants in environmental water, as well as pharmacokinetic studies and clinical tests in drug development. In general, the amount of measurement data (e.g., chromatogram data) acquired by a multi-analyte multi-component analysis is considerably large, and so is the amount of quantification results obtained by a quantitative analysis on those measurement data. Therefore, in order to improve the efficiency of an analyzing task performed by a user for the checking or verification of the measurement results or quantification results obtained for multiple components in multiple analytes, it is important to display the measurement results and quantification results by a simple operation, with a high level of efficiency, and in such a manner that the user barely mistakes one piece of information for another or misses a piece of important information.

As a software product for meeting those requirements, multi-analyte quantification software as disclosed in Non Patent Literatures 1 and 2 (or other related documents) has been available. As disclosed in Non Patent Literatures 1 and 2 as well as Patent Literature 1 (and other related documents), this multi-analyte quantification software creates a two-dimensional table in which pieces of information corresponding to different samples (e.g., sample names) are arranged in the row (horizontal) direction while pieces of information corresponding to different compounds (e.g., compound names) are arranged in the column (vertical) direction, with each cell of the table containing numerical information, such as a peak area value or quantitative value. This table is displayed on the screen of a display unit. By displaying such a table, the software allows the user to check the quantitative value or other kinds of numerical information in a list for each of the combinations of a large number of samples and a large number of kinds of compounds.

### CITATION LIST

### Patent Literature

Patent Literature 1: WO 2017/002156 A

### Non Patent Literature

Non Patent Literature 1: “LabSolutions Insight GC/MS & LC/MS You Takentai Teirvou Shien Sofutouea: LabSolutions Insight (LabSolutions Insight: Multi-Analyte Quantification Software LabSolutions Insight for GC/MS & LC/MS)”, [online], Shimadzu Corporation. [accessed on Feb. 1, 2022], the Internet
Non Patent Literature 2: “LabSolutions Insight GCMS You Takentai Teiryou Shien Sofutouea (LabSolutions Insight: Multi-Analyte Quantification Software for GCMS)”, [online], Shimadzu Corporation. [accessed on Feb. 1, 2022], the Internet

### SUMMARY OF INVENTION

### Technical Problem

In a multi-analyte multi-component analysis, the quantification result table as described earlier normally has a considerably large number of rows and columns. However, it is often the case that the user focuses on only a portion of the table. What type of result the user focuses on varies depending on the purpose of the measurement, kind of samples and other factors. It is often impossible to appropriately narrow down the results by a simple criterion, such as whether the quantitative value exceeds a reference value. For example, the user's attention may be focused on a quantitative value corresponding to the combination of a specific sample and a specific compound, as in the case of searching for a sample in which the concentration of a specific compound is particularly higher or lower than in the other samples, or in the case of searching for a compound whose concentration in one sample is particularly higher or lower than those of the other compounds in the same sample. In such a case, the user may want to extract that specific kind of numerical information and keep it in the form of a report or save it as a data file on a computer. The conventional multi-analyte quantification software also has a filtering function that can be used for extracting and outputting the quantitative values of all compounds obtained for a specific sample or the quantitative values of a specific compound obtained for all samples, for example.

However, an output produced by this function contains unnecessary pieces of information other than those which the user focuses on. Therefore, the task of checking the quantification results requires a considerable amount of time and labor, which is not only inefficient but is also likely to cause incorrect operations, such as a piece of important information being omitted in the check or even overlooked. In particular, a report prepared as a hard copy or saved as an electronic data file often contains not only the quantification results but also the peak waveforms of the chromatograms and the calibration curves used for the quantitative calculation as well as other pieces of information. Therefore, a considerable amount of time and labor will be consumed to locate a desired piece of information if there are lots of unnecessary information. The presence of unnecessary information also increases the number of pages of the report, which makes the report cumbersome as well as incurs an unnecessary cost in any of the two cases, i.e., a hard copy or an electronic file.

The present invention has been developed in view of these problems. Its primary objective is to provide a chromatographic analyzer and a computer program for chromatographic analysis which allow a user to efficiently check desired measurement results and quantification results (and the like) by convenient operations, while decreasing incorrect operations in the checking task.

### Solution to Problem

One mode of the chromatographic analyzer according to the present invention developed for solving the previously described problem is a chromatographic analyzer configured to perform a measurement on a plurality of compounds for each of a plurality of samples, including:

a data-analysis processor configured to calculate, for each sample, a plurality of pieces of numerical information which are results of data analysis on the plurality of compounds, based on data obtained by a measurement;

a table creator configured to create a two-dimensional table by arranging a plurality of sample identifiers which identify the plurality of samples in one of the horizontal and vertical directions of the table and a plurality of compound identifiers which identify the plurality of compounds in the other direction, as well as assigning one of the plurality of pieces of numerical information obtained for a combination of one sample and one compound to a cell of the table corresponding to the combination;

a cell selection receiver configured to display the table on a screen of a display section and receive a selection of a cell or cells according to an operation by a user on the displayed table; and

a selected information outputter configured to output or display the numerical information in the cell or cells received by the cell selection receiver, in a predetermined format and along with the sample identifier and the compound identifier corresponding to the cell or cells.

One mode of the program for chromatographic analysis according to the present invention is a data-processing program to be used for a chromatographic analyzer configured to perform a measurement on a plurality of compounds for each of a plurality of samples, the program configured to cause a computer to perform:

a data-analysis processing step for calculating, for each sample, a plurality of pieces of numerical information which are results of data analysis on the plurality of compounds, based on data obtained by a measurement:

a table creation step for creating a two-dimensional table by arranging a plurality of sample identifiers which identify the plurality of samples in one of the horizontal and vertical directions of the table and a plurality of compound identifiers which identify the plurality of compounds in the other direction, as well as assigning one of the plurality of pieces of numerical information obtained for a combination of one sample and one compound to a cell of the table corresponding to the combination;

a cell selection receiving step for displaying the table on a screen of a display section and receive a selection of a cell or cells according to an operation by a user on the displayed table; and

a selected information output step for outputting or displaying the numerical information in the cell or cells received in the cell selection receiving step, in a predetermined format and along with the sample identifier and the compound identifier corresponding to the cell or cells.

### Advantageous Effects of Invention

By the previously described modes of the chromatographic analyzer and the program for chromatographic analysis according to the present invention, a user (operator) can create a data file, and/or prepare and display a report, in which only specific pieces of numerical information that the user focuses on as well as the corresponding sample identifier and compound identifier are extracted, by performing a convenient operation in which a cell or cells showing the numerical information that the user focuses on are selected in the table displayed on the screen of the display section. Since the thereby extracted information does not include unnecessary information which the user focuses on, the user can efficiently check quantification results and other kinds of data-analysis results. Incorrect operations, such as an omission of the check or the mistaking of one piece of information for another, can be decreased. Furthermore, since the number of pages of the report and the amount of data in the electronic file of the report become smaller than conventional, the report or file becomes easier to handle, and the related cost is reduced.

### BRIEF DESCRIPTION OF DRAWINGS

FIG. 1 is a schematic configuration diagram of an LC-MS system as one embodiment of the present invention.

FIG. 2 is a flowchart showing one example of the steps and processing for exporting quantification results in the LC-MS system according to the present embodiment.

FIG. 3 is a diagram showing one example of a quantification result table in the LC-MS system according to the present embodiment.

FIG. 4 is a diagram showing one example of an export condition setting screen in the LC-MS system according to the present embodiment.

FIG. 5 is a diagram showing one example of the display of the export result in the LC-MS system according to the present embodiment.

FIG. 6 is a diagram showing one example of a report condition setting screen in the LC-MS system according to the present embodiment.

FIG. 7 is a diagram showing one example of the report created in the LC-MS system according to the present embodiment.

### DESCRIPTION OF EMBODIMENTS

An LC-MS system as one embodiment of the chromatographic analyzer according to the present invention is hereinafter described referring to the attached drawings.

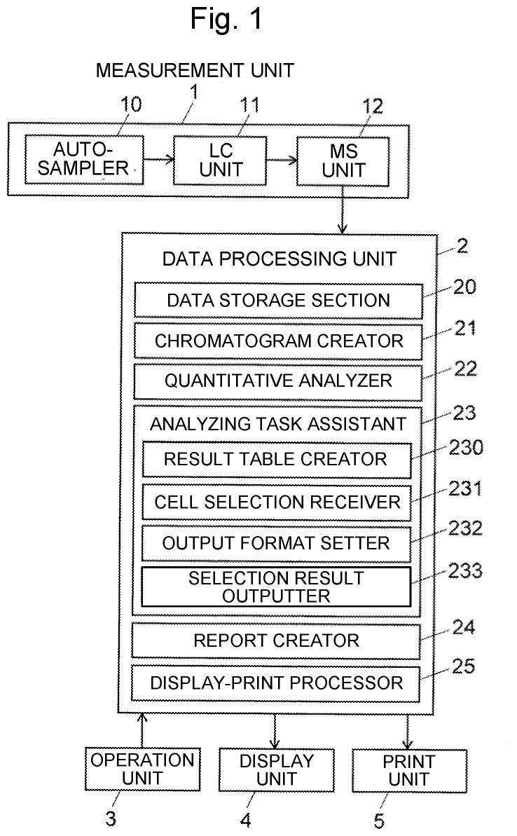

FIG. 1 is a schematic configuration diagram of an LC-MS system according to the present embodiment.

This LC-MS system includes a measurement unit 1, data processing unit 2, operation unit 3, display unit 4 and print unit 5.

The measurement unit 1 includes an autosampler 10 having the function of selecting a large number of prepared samples in a predetermined order, a liquid chromatograph unit (LC unit) 11 configured to temporally separate compounds contained in a sample, as well as a mass spectrometry unit (MS unit) 12 configured to ionize a compound and detect the thereby produced ions. The following descriptions assume that the MS unit 12 is a single-type quadrupole mass spectrometer, although a tandem-type mass spectrometer can also be used, such as a triple quadrupole mass spectrometer or quadrupole time-of-flight mass spectrometer.

The data processing unit 2 includes, as its functional blocks, a data storage section 20, chromatogram creator 21, quantitative analyzer 22, analyzing task assistant 23, report creator 24 and display-print processor 25. The analyzing task assistant 23 includes, as its sub-functional blocks, a result table creator 230, cell selection receiver 231, output format setter 232 and selection result outputter 233.

The data processing unit 2 can be created by using a personal computer including a CPU, RAM, ROM and other devices as hardware components, with at least some of its functions realized by executing, on the computer, a piece of dedicated data-processing software (computer program) installed on the same computer.

The computer program can be offered to users in the form of a non-transitory computer-readable record medium holding the program, such as a CD-ROM, DVD-ROM, memory card, or USB memory (dongle). The program may also be offered to users in the form of data transferred through the Internet or similar communication networks. The program can also be preinstalled on a computer (or more exactly, on a storage device as a component of a computer) as a part of a system before a user purchases the system.

Hereinafter initially given is a schematic description of a measurement operation performed in the measurement unit 1 when a multi-analyte multi-component quantification analysis is carried out in the LC-MS system according to the present embodiment. In this case, a plurality of (normally, a considerable number of) compounds to be subjected to the measurement are previously determined, and the retention time and the mass-to-charge ratio value m/z of the target ion are previously known for each compound. That is to say, those pieces information are given beforehand.

The autosampler 10 holds a large number of samples (analytes). Under the control of a control unit (not shown), the autosampler 10 sequentially selects those samples in a predetermined order and sends the selected sample to the LC unit 11. Though not shown, in the LC unit 11, a liquid-sending pump supplies a mobile phase to a column at a substantially constant flow velocity, and an injector injects a predetermined amount of sample into the mobile phase at a predetermined timing. The injected sample is carried by the mobile phase and introduced into the column. While the sample is passing through the column, the components in the sample are temporally separated from each other.

The eluate exiting from the exit end of the column is introduced into the MS unit 12. Though not shown, the MS unit 12 includes an ion source, which ionizes the compound in the eluate. The resulting ions are separated from each other by a quadrupole mass filter according to their m/z values, and an ion having a specific m/z value is selected by the mass filter and detected by an ion detector. The detection signals produced by the ion detector are converted into digital signals and sent to the data processing unit 2, in which those signals are stored in the data storage section 20.

In a multi-component quantification analysis, the quadrupole mass filter in the MS unit 12 is driven so as to selectively allow an ion having an m/z value corresponding to a target compound to pass through the same filter during a predetermined period of time around the retention time at which the target compound is introduced into the MS unit 12. In other words, a selected ion monitoring (SIM) measurement for the ion corresponding to the target compound is performed for each of the large number of target compounds. After an LC/MS measurement for a predetermined range of measurement time for one sample has been completed, the autosampler 10 selects the next sample and sends it to the LC unit 11. The LC unit 11 and the MS unit 12 repeat a similar LC/MS measurement to the previous description. In the case where a tandem mass spectrometer is used as the MS unit 12, an MRM measurement for a multiple reaction monitoring (MRM) transition corresponding to the target compound can be performed in place of the SIM measurement.

Thus, in the data storage section 20, a set of measurement data is stored for each sample, where the measurement data covers predetermined ranges of time each of which is defined around a retention time corresponding to one of the large number of target compounds, showing a temporal change of the intensity of an ion having a specific m/z value within each range of time. That is to say, a set of measurement data forming an extracted ion chromatogram (EIC) is stored. This set of data is used for the quantitative calculation of the target compounds.

Next, a multi-analyte multi-component quantification analysis performed in the data processing unit 2 is described.

In the data processing unit 2, the chromatogram creator 21 reads the measurement data corresponding to one sample from the data storage section 20 and creates an extracted ion chromatogram for each target compound. If a certain target compound is actually contained in the sample, a peak appears in the extracted ion chromatogram corresponding to that target compound. The quantitative analyzer 22 performs a peak-detecting process on each extracted ion chromatogram and calculates a peak area (or peak height) if a peak has been detected. Referring to the calibration curve created by analyzing a standard sample, the quantitative analyzer 22 calculates the concentration value of each target compound from its peak area value. Thus, for each sample, the concentration values of the target compounds are obtained as the quantitative values.

The quantitative analyzer 22 stores the concentration value calculated for each target compound, the peak area value determined in the process of the calculation of the concentration value, the retention time determined from the peak-top position as well as various other kinds of numerical information, in the data storage section 20 in such a manner that those pieces of information are related to the measurement data or saved in the file or folder in which the measurement data is also saved. It should be noted that the quantitative analysis by the quantitative analyzer 22 may be performed as a batch process after the completion of all measurements for the large number of samples, or as a sequential process for every completion of the measurement for one or more of the large number of samples (i.e., in the middle of the sequence of measurements).

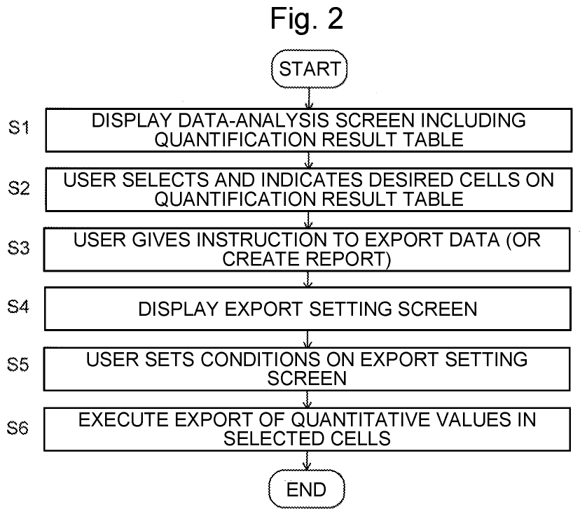

In any case, after the multi-analyte multi-component quantification analysis has been completed, a huge amount of measurement data, quantification results and other related pieces of information for a large number of samples are held in the data storage section 20. In this state, a characteristic data-processing operation is performed, mainly by the analyzing task assistant 23, as will be hereinafter described referring to FIGS. 2-7.

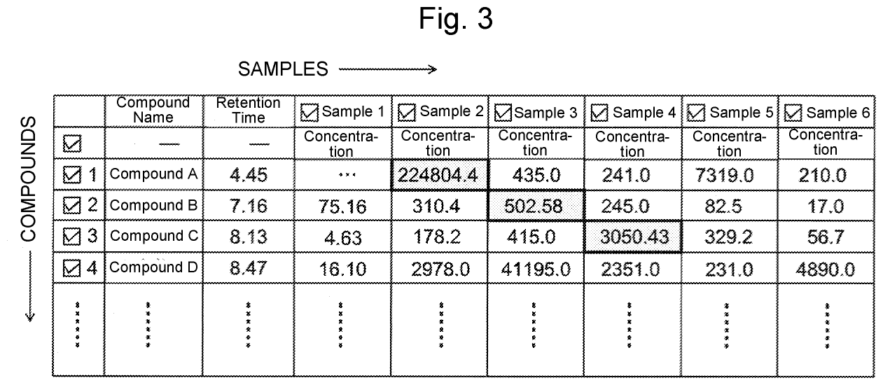

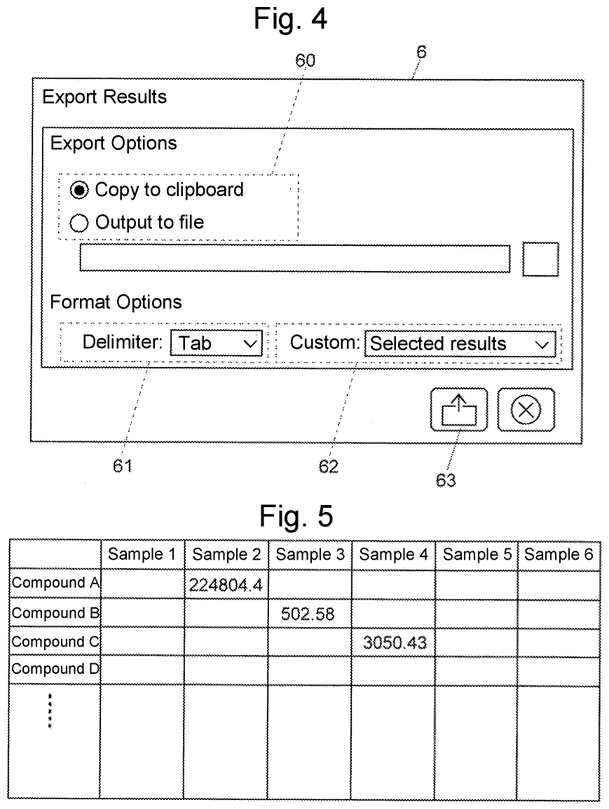

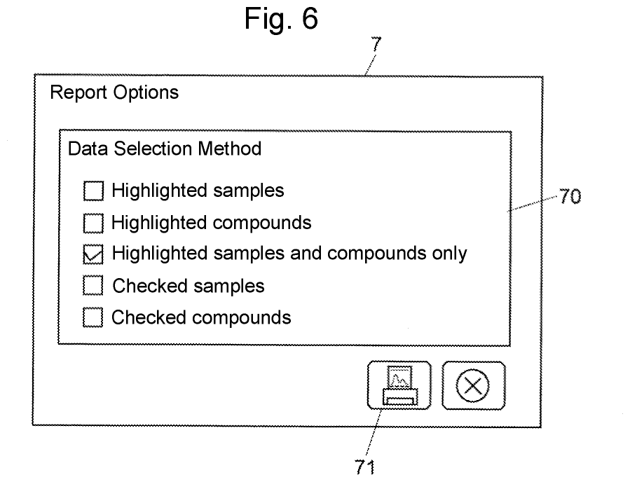

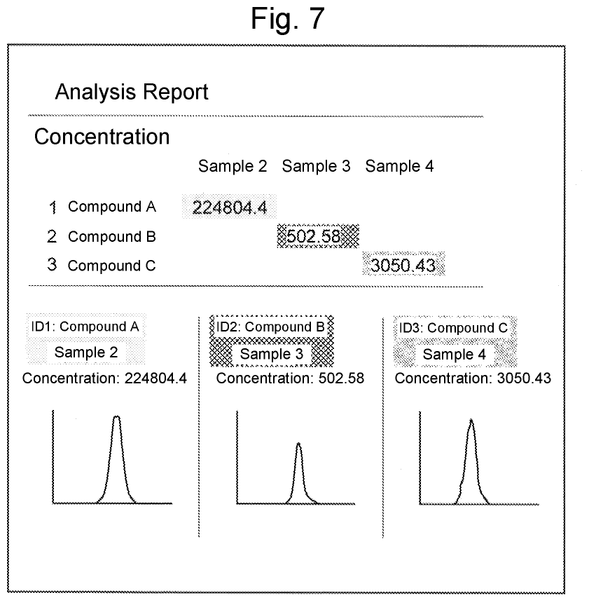

FIG. 2 is a flowchart showing one example of the steps and processing for exporting quantification results in the LC-MS system according to the present embodiment. FIG. 3 is a diagram showing one example of a quantification result table. FIG. 4 is a diagram showing one example of an export condition setting screen. FIG. 5 is a diagram showing one example of the display of the export result. FIG. 6 is a diagram showing one example of a report condition setting screen. FIG. 7 is a diagram showing one example of the report.

By using the operation unit 3, a user issues a command to display a comprehensive view of the quantification results sequentially obtained for a large number of samples. Then, the result table creator 230 creates a quantification result table showing the concentration value and other kinds of numerical information listed for each combination of one sample and one compound, based on the information read from the data storage section 20. The display-print processor 25 displays a data-analysis screen including the quantification result table on the screen of the display unit 4 (Step S1).

The quantification result table is a matrix-like table with each column corresponding to a sample identifier and each row corresponding to a compound identifier, as illustrated in FIG. 3, or conversely, with each column corresponding to a compound identifier and each row corresponding to a sample identifier. Each cell of the table contains a piece of numerical information corresponding to a combination of one sample and one compound. In FIG. 3, “Sample 1”, “Sample 2”, . . . are examples of the sample identifier, while “Compound A”, “Compound B”, . . . are examples of the compound identifier. The sample identifier may be any type of information by which each sample can be uniquely identified, such as the sample name or sample number. Similarly, the compound identifier may be any type of information by which each compound can be uniquely identified, such as the compound name, compound number (serial number), or CAS registry number. As for the numerical information in each cell, which is the concentration value in the present example, other kinds of numerical information may be displayed, such as a peak area value or peak-top retention time.

The data-analysis screen including the quantification result table may also show other kinds of information along with the table, such as a peak waveform of an extracted ion chromatogram corresponding to a specific combination of a sample and a compound selected on the table, or the calibration curve used for the quantitative analysis.

The quantification result table shows the numerical information for all combinations of the samples and the compounds. However, in many cases, the user focuses on only some of those combinations. Therefore, the user often desires to create a separate table which selectively shows specific pieces of numerical information corresponding to the combinations which the user focuses on, or to create a report of the data-analysis result including those pieces of information. In that case, the user selects and indicates one or more cells which show the combinations (or concentration values) that the user focuses on in the quantification result table displayed on the screen, using a mouse or similar pointing device in the operation unit 3 (Step S2). Understandably, if the display unit 4 is a touch panel display, the user can perform the selecting and indicating operation by touching the display with a finger, without using the operation unit 3.

The number of cells to be selected may be any number. The selection may be made by a clicking operation in each cell. As another possibility, a plurality of cells may be selected simultaneously by a different type of operation, e.g., by dragging a mouse over a plurality of adjacent cells while pressing and holding down a mouse button (or the like).

FIG. 3 shows the state in which three cells [Sample 2×Compound A], [Sample 3×Compound B] and [Sample 4×Compound C] have been selected. The selected cells are highlighted so that they can be easily distinguished from the other cells by sight on the display.

When the user wants to export the numerical information in the selected cells to create a new table, the user clicks an export button on the data-analysis screen, with one or more cells selected in the previously described manner (Step S3). The output format setter 232 receives this instruction and displays an export setting screen 6, as illustrated in FIG. 4, on the data-analysis screen (Step S4).

The export setting screen 6 is a screen for setting the conditions for exporting the numerical information described in the quantification result table. As shown in FIG. 4, this screen has an output destination selection area 60, output format selection area 61, output information selection area 62 and execution button 63. As for the output destination, two options are prepared: “copy to clipboard”, which is a temporary storage area in the computer, and “output to file”. For an output to a file, the user should select the “output to file” option and enters the file name. In the example of FIG. 4, the “copy to clipboard” option is selected as the output destination.

In the output format selection area 61, a text file using the tab as the delimiter, a text file using the comma as the delimiter (CSV format) or other output formats can be selected. When the user wants to output only the information related to the cells selected in the previously described manner, the user should select the “selected result” option in the output information selection area 62. There are also other options, such as the output of the results in all cells, or the output of the results of a specific sample or compound checked in the quantification result table (the results in one entire row or one entire column in the table). After selecting these conditions for the export (Step S5), the user clicks the execution button 63.

In response to the operation on the execution button 63, the selection result outputter 233 exports the sample identifier and the compound identifier corresponding to the cells selected in the quantification result table, as well as the concentration values in those cells, to the clipboard or file according to the conditions set in the export setting screen 6 (Step S6).

For example, a text file outputted to the clipboard can be imported into a spreadsheet software application, such as Microsoft® Excel®, and displayed in the form of a table which contains the concentration values only in the selected cells, with the other cells blanked, as illustrated in FIG. 5. The display format of the table can be appropriately selected; for example, all cells corresponding to a sample identifier or compound identifier for which no concentration value is displayed may be deleted before the table is displayed. Thus, since only the pieces of information which the user focuses on are displayed, the user can efficiently perform analyzing tasks. The probability of an incorrect analysis can also be reduced by preventing the user from incorrectly reading displayed numerical values or mistaking one numerical value for another.

On the other hand, when the user wants to create a report using the numerical information in the cells selected in Step S2, the user should click a report creation button on the data-analysis screen in Step S3, with one or more cells selected in the previously described manner. The output format setter 23 receives this instruction and displays a report condition setting screen 7, as illustrated in FIG. 6, on the data-analysis screen.

The report condition setting screen 7 is a screen for setting the conditions for preparing a report including the numerical information described in the quantification result table (or more exactly, for creating a document file similar to a printed version). As shown in FIG. 6, this screen includes a data selection area 70 and an execution button 71. As for the data selection method, a plurality of options are prepared, including the “highlighted samples” option. When only the concentration values in the selected cells should be used in the report, the “highlighted samples and compounds only” option can be selected, as shown in FIG. 6. The user subsequently clicks the execution button 71.

In response to the operation on the execution button 71, the report creator 24 prepares a report in a predetermined format as a document file (e.g., in the PDF format) including the sample identifier and the compound identifier corresponding to the cells selected in the quantification result table as well as the concentration values in those cells. The report can be visualized by opening the created document file with a specified software application. FIG. 7 shows an example of the report, which includes: a concentration-value table in which the sample identifier and the compound identifier corresponding to the selected cells as well as the concentration values in those cells are collected; and the peak waveforms of the extracted ion chromatograms used as a basis for calculating the concentration values. In this manner, the user can prepare a report which selectively includes the pieces of information which the user focuses on. The items of information to be included in the report can be appropriately added or deleted. The format of the report is not limited to the previously illustrated one.

As described thus far, by the LC-MS system according to the present embodiment, the user can export the sample identifier, compound identifier and numerical information corresponding to appropriately selected cells as text data, or create a report including only those pieces of information, by performing simple operations on the quantification result table in which the numerical information, such as the concentration values, are collected.

Although the previous embodiment is an example in which the present invention is applied in an LC-MS, it is evident that the present invention can be generally applied in any chromatograph system which can acquire a chromatogram and perform a quantitative analysis based on that chromatogram. In other words, the present invention is applicable not only in an LC-MS but also in a wide range of devices, including GC-MS, LC, GC and SFC.

The previous embodiment and its various modified examples described thus far are mere examples of the present invention. Any modification, change or addition appropriately made within the gist of the present invention will naturally fall within the scope of claims of the present application.

[Various Modes]

It is evident for a person skilled in the art that the previously described illustrative embodiment is a specific example of the following modes of the present invention.

(Clause 1) One mode of the chromatographic analyzer according to the present invention is a chromatographic analyzer configured to perform a measurement on a plurality of compounds for each of a plurality of samples, including:

a data-analysis processor configured to calculate, for each sample, a plurality of pieces of numerical information which are results of data analysis on the plurality of compounds, based on data obtained by a measurement;

a table creator configured to create a two-dimensional table by arranging a plurality of sample identifiers which identify the plurality of samples in one of the horizontal and vertical directions of the table and a plurality of compound identifiers which identify the plurality of compounds in the other direction, as well as assigning one of the plurality of pieces of numerical information obtained for a combination of one sample and one compound to a cell of the table corresponding to the combination;

a cell selection receiver configured to display the table on a screen of a display section and receive a selection of a cell or cells according to an operation by a user on the displayed table; and

a selected information outputter configured to output or display the numerical information in the cell or cells received by the cell selection receiver, in a predetermined format and along with the sample identifier and the compound identifier corresponding to the cell or cells.

The chromatographic analyzer according to Clause 1 includes a liquid chromatographic analyzer, gas chromatographic analyzer, liquid chromatograph mass spectrometer, gas chromatograph mass spectrometer and supercritical fluid chromatographic analyzer.

(Clause 6) One mode of the program for chromatographic analysis according to the present invention is a data-processing program to be used for a chromatographic analyzer configured to perform a measurement on a plurality of compounds for each of a plurality of samples, the program configured to cause a computer to perform:

a data-analysis processing step for calculating, for each sample, a plurality of pieces of numerical information which are results of data analysis on the plurality of compounds, based on data obtained by a measurement;

a table creation step for creating a two-dimensional table by arranging a plurality of sample identifiers which identify the plurality of samples in one of the horizontal and vertical directions of the table and a plurality of compound identifiers which identify the plurality of compounds in the other direction, as well as assigning one of the plurality of pieces of numerical information obtained for a combination of one sample and one compound to a cell of the table corresponding to the combination:

a cell selection receiving step for displaying the table on a screen of a display section and receive a selection of a cell or cells according to an operation by a user on the displayed table and

a selected information output step for outputting or displaying the numerical information in the cell or cells received in the cell selection receiving step, in a predetermined format and along with the sample identifier and the compound identifier corresponding to the cell or cells.

By the chromatographic analyzer according to Clause 1 and the program for chromatographic analysis according to Clause 6, a user (operator) can create a data file or report in which only specific pieces of numerical information that the user focuses on are extracted, and display those specific pieces of information, by performing a convenient operation for selecting the cell or cells holding those specific pieces of information on the table displayed on the screen. Since the information thus extracted does not include unnecessary information which the user focuses on, the user can efficiently check measurement results, quantification results and the like. Incorrect operations by the user, such as an omission of the check or the mistaking of one piece of information for another, can be decreased. Furthermore, since the number of pages of the report and the amount of data in the electronic file of the report are decreased, the report or file becomes easy to handle, and the related cost is also reduced.

(Clause 2) The chromatographic analyzer according to Clause 1 may further include an operation section configured to allow a user to indicate any position on the screen of the display section by a clicking operation, and the cell selection receiver may be configured to receive the selection of a cell according to the clicking operation using the operation section on the displayed table.

(Clause 7) In the program for chromatographic analysis according to Clause 6, the cell selection receiving step may include receiving the selection of a cell according to a clicking operation by a user at a position corresponding to the cell on the table displayed on the screen of the display section.

By the chromatographic analyzer according to Clause 2 and the program for chromatographic analysis according to Clause 7, the user can select and indicate a desired cell or cells by a simple, intuitively understandable operation. This improves the working efficiency as well as decreases incorrect operations.

(Clause 3) The chromatographic analyzer according to Clause 1 or 2 may further include a report creator configured to create a report in a predetermined format, and

the selected information outputter may be configured to output the numerical information of the selected cell or cells as well as the corresponding sample identifier and compound identifier to the report creator, and the report creator creates a report including the numerical information of the cell or cells as well as the corresponding sample identifier and compound identifier.

(Clause 8) The program for chromatographic analysis according to Clause 6 or 7 may further cause the computer to perform a report creation step for receiving, from the selected information output step, the numerical information of the selected cell or cells as well as the corresponding sample identifier and compound identifier, and for creating a report in a predetermined format including the numerical information of the cell or cells as well as the corresponding sample identifier and compound identifier.

By the chromatographic analyzer according to Clause 3 and the program for chromatographic analysis according to Clause 8, the user can create a report which includes numerical information (e.g., concentration values) corresponding to the combinations of the samples and compounds which the user focuses on, while omitting the concentration values corresponding to the other unnecessary combinations which the user does not focus on. Therefore, the user can obtain a useful report which exclusively include information which the user focuses on. The omission of the unnecessary information also reduces the amount of information of the report, so that a waste of paper can be avoided in the case of producing a hard copy of the report, or a waste of storage capacity can be avoided by reducing the amount of data in the case of saving the report as a data file.

(Clause 4) In the chromatographic analyzer according to Clause 3, the report creator may be configured to create a report including a peak waveform of a chromatogram corresponding to the numerical information.

(Clause 9) In the program for chromatographic analysis according to Clause 8, the report creation step may include creating a report including a peak waveform of a chromatogram corresponding to the numerical information.

In the chromatographic analyzer according to Clause 4 and the program for chromatographic analysis according to Clause 9, the report shows not only the concentration value and other related pieces of information corresponding to each combination of the sample and compound which the user focuses on, but also a peak waveform of the chromatogram used as a basis for calculating the concentration value. Therefore, the user can efficiently determine, on the report, whether or not there is any problem in the peak waveform used as a basis for calculating the concentration value.

(Clause 5) The chromatographic analyzer according to one of Clauses 1-4 may further include an output format setter configured to receive a selection of a mode by a user from a plurality of modes including a mode for outputting the numerical information corresponding to a selected cell, a mode for outputting the numerical information corresponding to a selected sample, and a mode for outputting the numerical information corresponding to a selected compound, and the selected information outputter may be configured to output information including the numerical information according to the selected mode.

(Clause 10) The program for chromatographic analysis according to one of Clauses 6-9 may further cause the computer to perform an output format setting step for receiving a selection of a mode by a user from a plurality of modes including a mode for outputting the numerical information corresponding to a selected cell, a mode for outputting the numerical information corresponding to a selected sample, and a mode for outputting the numerical information corresponding to a selected compound, and the selected information output step may include outputting information including the numerical information according to the mode selected in the output format setting step.

The chromatographic analyzer according to Clause 5 and the program for chromatographic analysis according to Clause 10 can output information not only in a format for outputting only the information corresponding to the cell or cells which the user focuses on, but also in a format for outputting all concentration values and related numerical information corresponding to a specific sample or specific compound when the user desires this format. By this function, a variety of output formats can be supported according to various requests of the user, so that an output or report which includes appropriate items of information that the user wants to check can be created.

### REFERENCE SIGNS LIST

1 . . . Measurement Unit
10 . . . Autosampler
11 . . . Liquid Chromatograph Unit (LC Unit)
12 . . . Mass Spectrometry Unit (MS Unit)
2 . . . Data Processing Unit
20 . . . Data Storage Section
21 . . . Chromatogram Creator
22 . . . Quantitative Analyzer
23 . . . Analyzing Task Assistant
230 . . . Analysis Result Table Creator
231 . . . Cell Selection Receiver
232 . . . Output Format Setter
233 . . . Selection Result Outputter
24 . . . Report Creator
25 . . . Display-Print Processor
3 . . . Operation Unit
4 . . . Display Unit
5 . . . Print Unit

1. A chromatographic analyzer configured to perform a measurement on a plurality of compounds for each of a plurality of samples, comprising:
a data-analysis processor configured to calculate, for each sample, a plurality of pieces of numerical information which are results of data analysis on the plurality of compounds, based on data obtained by a measurement;
a table creator configured to create a two-dimensional table by arranging a plurality of sample identifiers which identify the plurality of samples in one of horizontal and vertical directions of the table and a plurality of compound identifiers which identify the plurality of compounds in the other direction, as well as assigning one of the plurality of pieces of numerical information obtained for a combination of one sample and one compound to a cell of the table corresponding to the combination;
a cell selection receiver configured to display the table on a screen of a display section and receive a selection of a cell or cells according to an operation by a user on the displayed table; and
a selected information outputter configured to output or display the numerical information in the cell or cells received by the cell selection receiver, in a predetermined format and along with the sample identifier and the compound identifier corresponding to the cell or cells.

2. The chromatographic analyzer according to claim 1, further comprising an operation section configured to allow a user to indicate any position on the screen of the display section by a clicking operation, wherein the cell selection receiver is configured to receive the selection of a cell according to the clicking operation using the operation section on the displayed table.

3. The chromatographic analyzer according to claim 1, further comprising:
a report creator configured to create a report in a predetermined format,
wherein the selected information outputter is configured to output the numerical information of the selected cell or cells as well as the corresponding sample identifier and compound identifier to the report creator, and the report creator creates a report including the numerical information of the cell or cells as well as the corresponding sample identifier and compound identifier.

4. The chromatographic analyzer according to claim 3, wherein the report creator is configured to create a report including a peak waveform of a chromatogram corresponding to the numerical information.

5. The chromatographic analyzer according to claim 1, further comprising an output format setter configured to receive a selection of a mode by a user from a plurality of modes including a mode for outputting the numerical information corresponding to a selected cell, a mode for outputting the numerical information corresponding to a selected sample, wherein a mode for outputting the numerical information corresponding to a selected compound, wherein the selected information outputter outputs information including the numerical information according to the selected mode.

6. A non-transitory computer readable record medium holding a program for chromatographic analysis which is a data-processing program to be used for a chromatographic analyzer configured to perform a measurement on a plurality of compounds for each of a plurality of samples, the program configured to cause a computer to perform:
a data-analysis processing step for calculating, for each sample, a plurality of pieces of numerical information which are results of data analysis on the plurality of compounds, based on data obtained by a measurement;
a table creation step for creating a two-dimensional table by arranging a plurality of sample identifiers winch identify the plurality of samples in one of horizontal and vertical directions of the table and a plurality of compound identifiers which identify the plurality of compounds in the other direction, as well as assigning one of the plurality of pieces of numerical information obtained for a combination of one sample and one compound to a cell of the table corresponding to the combination;
a cell selection receiving step for displaying the table on a screen of a display section and receive a selection of a cell or cells according to an operation by a user on the displayed table; and
a selected information output step for outputting or displaying the numerical information in the cell or cells received in the cell selection receiving step, in a predetermined format and along with the sample identifier and the compound identifier corresponding to the cell or cells.

7. The non-transitory computer readable record medium holding a program for chromatographic analysis according to claim 6, wherein the cell selection receiving step includes receiving the selection of a cell according to a clicking operation by a user at a position corresponding to the cell on the table displayed on the screen of the display section.

8. The non-transitory computer readable record medium holding a program for chromatographic analysis according to claim 6, wherein the program is configured to further cause the computer to perform a report creation step for receiving, from the selected information output step, the numerical information of the selected cell or cells as well as the corresponding sample identifier and compound identifier, and for creating a report in a predetermined format including the numerical information of the cell or cells as well as the corresponding sample identifier and compound identifier.

9. The non-transitory computer readable record medium holding a program for chromatographic analysis according to claim 8, wherein the report creation step includes creating a report including a peak waveform of a chromatogram corresponding to the numerical information.

10. The non-transitory computer readable record medium holding a program for chromatographic analysis according to claim 6, the program is configured to further cause the computer to perform an output format setting step for receiving a selection of a mode by a user from a plurality of modes including a mode for outputting the numerical information corresponding to a selected cell, a mode for outputting the numerical information corresponding to a selected sample, and a mode for outputting the numerical information corresponding to a selected compound, and the selected information output step includes outputting information including the numerical information according to the mode selected in the output format setting step.
